(19) United States
(12) Patent Application Publication
(10) Pub. No.: US 2015/0285994 A1
(43) Pub. Date: Oct. 8, 2015

(54) MANUFACTURING METHOD AND MANUFACTURING APPARATUS OF OPTICAL FIBER

(71) Applicant: Fujikura Ltd., Tokyo (JP)

(72) Inventor: Kenji OKADA, Sakura-shi (JP)

(73) Assignee: Fujikura Ltd., Tokyo (JP)

(21) Appl. No.: 14/679,402

(22) Filed: Apr. 6, 2015

(30) Foreign Application Priority Data
Apr. 7, 2014 (JP) 2014-078738

(51) Int. Cl. G02B 6/02; C03B 37/027; C03C 25/10; C03B 37/025

(52) U.S. Cl. CPC G02B 6/02285; C03B 37/0253; C03B 37/02718; C03B 37/02736; C03C 25/104; C03B 2203/36; C03B 2205/06

(57) ABSTRACT

A manufacturing method of an optical fiber includes: heating and melting an optical fiber preform; drawing a bare optical fiber from a heated and melted portion of the optical fiber preform; cooling the bare optical fiber drawn from the optical fiber preform; forming a coating layer on a surface of the cooled bare optical fiber; obtaining an optical fiber by curing the coating layer; adding torsion to the optical fiber by transmitting the torsion up to the heated and melted portion through the bare optical fiber from the optical fiber so that spin is applied to the bare optical fiber; and winding the optical fiber.

### BACKGROUND OF THE INVENTION

1. Field of the Invention

The present invention relates to a manufacturing method and a manufacturing apparatus of an optical fiber, and particularly to a manufacturing method and a manufacturing apparatus of an optical fiber in which the increased degree of the polarization mode dispersion (PMD) in the optical fiber is small even in a state in which disturbance such as lateral pressure or bending is applied to the optical fiber.

Priority is claimed on Japanese Patent Application No. 2014-078738, filed on Apr. 7, 2014, the content of which is incorporated herein by reference.

2. Description of Related Art

Regardless of the method used to manufacture an optical fiber preform or the method used to draw an optical fiber preform for a manufactured optical fiber, it is difficult to make the cross-sectional shape, in which a core portion of the optical fiber and a cladding portion around the core portion are included, truly circular. In actual cases, the cross-sectional shape forms a slightly oval shape or a distorted shape. Therefore, the refractive index profile in the cross-section of the optical fiber is also not completely concentric and, consequently, birefringence is generated. This birefringence causes a difference in the group velocity between two polarized waves orthogonal to each other in the cross-section of the optical fiber and there is a problem in that the polarization mode dispersion (hereinafter, referred to as “PMD”) increases. The above-described PMD is the PMD generated due to the internal factors of the optical fiber. Also, birefringence is also generated due to external factors such as bending or lateral pressure applied to the optical fiber and thus the PMD changes.

In order to reduce the PMD generated due to the internal factors, a method is carried out in which permanently-fixed torsion (hereinafter, refer to “spin”) is applied to a bare optical fiber by applying torsion to the heated and melted portion of an optical fiber during the drawing of the optical fiber (refer to U.S. Pat. No. 6,324,872 and Japanese Patent No. 3557606).

In addition, in order to reduce the PMD generated due to the external factors, a method is carried out in which elastic torsion (torsion that is released when a force is relieved, hereinafter referred to as “twist”) is applied to the optical fiber (refer to U.S. Pat. No. 7,317,855, PCT International Publication No. WO2009-107667, and Japanese Unexamined Patent Application, First Publication No. 2010-122666).

### SUMMARY OF THE INVENTION

The application of spin is effective for the internal factors. However, the application of spin alone is not capable of reducing the PMD due to the external factors.

Also, the application of twist is effective for the external factors. However, when the optical fiber is colored or made into tape or a cable after the twist is applied, the applied torsion is released (refer to FIG. 3 in U.S. Pat. No. 7,317,855). Therefore, it is difficult to guarantee stable qualities. That is, when the optical fiber can be used for the final application, for example, a cable in a state in which the torsion remains, the PMD can be maintained at a low level in spite of the external factors; however, when the torsion is released, the PMD-reducing effect disappears.

In addition, there is a problem in that the PMD-reducing effect significantly changes by a slight change in the twist profile (the twist cycle that changes once between the clockwise twist direction and the counterclockwise twist direction and the twist amplitude which is the cumulative degree of the same-direction torsion, refer to FIG. 1) remaining in the optical fiber in a final form such as a cable (refer to FIG. 5 in U.S. Pat. No. 7,317,855). Regarding these problems, in PCT International Publication No. WO2009-107667, measures of modulating or randomizing the twist cycle or the twist amplitude are carried out, but the twist is somewhat released in the same manner in spite of the above-described measures. Therefore, in the finely-modulated twist profile, in the worst case, the twist is fully released in subsequent steps. Even when some of the twist is not released and remains, the modulation component in a short cycle or amplitude is released, consequently, in many cases, only twist of a long cycle component remains, and there remains a problem in that it is difficult to guarantee stable qualities of the products.

The present invention has been made in consideration of the above-described circumstances and an object of the present invention is to provide a manufacturing method and a manufacturing apparatus of an optical fiber capable of reducing both the PMD generated due to internal factors and the PMD generated due to external factors.

The present inventors repeated a variety of experiments and studies in order to solve the above-described problems. As a result, it was found that, in order to reduce the PMD for both internal factors and external factors, it is necessary to increase the non-circularity of the core in a bare optical fiber and apply spin to the bare optical fiber. Therefore, an optical fiber-drawing technique in which an optical fiber preform was heated and melted, was drawn, and torsion was applied to an optical fiber obtained by coating the bare optical fiber so as to apply spin to the bare optical fiber was improved. In a drawing step in which the optical fiber preform is heated and melted so as to draw out the bare optical fiber, glass is melted or softened and has plasticity in a wide range from the heated and melted portion of the optical fiber preform to the bare optical fiber. Since a non-circular core and spin are applied to glass having the above-described plasticity, it is possible to manufacture an optical fiber in which the non-circular core and the spin are fixed through cooling. When the non-circular core is generated in the glass, a non-circular cladding may be generated at the same time. In the obtained optical fiber, even in a step in which the optical fiber is made into a product for final application such as tape, a cord, or a cable or in other actual applications of the product, the PMD-suppressing effect is reliably maintained even when an external force is applied or relieved.

In a case in which the outer diameter of a bare optical fiber to which torsion has been applied by spin is measured in an outer diameter measurement instrument that measures the outer diameter of the drawn bare optical fiber, the non-circularity of the cladding can be easily obtained by dividing the fluctuation range (the difference between the maximum value and the minimum value) of the outer diameter measurement values by the outer diameter of the bare optical fiber (a set value or an average value). As described above, when the non-circularity of the cladding is easily obtained during a manufacturing step, it is possible to manufacture an optical fiber having desired characteristics with a favorable yield by providing feedback to the adjustment of the position of an optical fiber preform.

In order to solve the above-described problems, according to a first aspect of the present invention, there is provided a manufacturing method of an optical fiber including: heating and melting an optical fiber preform; drawing a bare optical fiber from a heated and melted portion of the optical fiber preform; cooling the bare optical fiber drawn from the optical fiber preform; generating a coating layer on a surface of the cooled bare optical fiber; obtaining an optical fiber by curing the coating layer; adding torsion to the optical fiber by transmitting the torsion up to the heated and melted portion through the bare optical fiber from the optical fiber so that spin is applied to the bare optical fiber; and winding the optical fiber. Also, when the bare optical fiber is drawn from the heated and melted portion, generating a non-circularity of a core in a range of 0.3% to 1% in the bare optical fiber is performed. Additionally, when the torsion is added to the optical fiber, applying the spin to the bare optical fiber is performed so that torsion in a first direction and torsion in a second direction, which is opposite to the first direction, are alternately present around a longitudinal direction of the bare optical fiber. Furthermore, when the torsion is added to the optical fiber, applying the spin to the bare optical fiber is performed so that a unidirectional torsion length in the spin becomes equal to or less than a beat length converted from birefringence generated due to a non-circular core and an amplitude of the spin indicating a degree of unidirectional torsion in the spin reaches 30 rad or more.

When the bare optical fiber is drawn from the heated and melted portion, the non-circular core may be generated so that birefringence generated due to the non-circularity of the core falls in a range of 10⁻⁷ to 10⁻⁹.

when the bare optical fiber is drawn from the heated and melted portion, the non-circular core may be generated so that a value of a ratio between birefringence generated due to the non-circularity of the core and birefringence by external factors expected to be applied in applications of the optical fiber falls in a range of 10⁻² to 10⁺².

When the bare optical fiber is drawn from the heated and melted portion, a non-circularity of a cladding in a range of 0.3% to 1% may be generated in the bare optical fiber.

When the optical fiber preform is heated and melted, a degree of the non-circularity of the cladding may be adjusted by misaligning a position of the optical fiber preform in a horizontal plane in the heating furnace from a center of the heating furnace, an outer diameter of the bare optical fiber screwed by the spin may be measured, and whether or not a fluctuation range of a measured outer diameter measurement value falls in a fluctuation range corresponding to a desired non-circularity of the cladding may be checked.

When the optical fiber preform is heated and melted, a degree of the non-circularity of the cladding may be adjusted by making a heater shape in the heating furnace oval in a horizontal plane, an outer diameter of the bare optical fiber screwed by the spin may be measured, and whether or not a fluctuation range of a measured outer diameter measurement value falls in a fluctuation range corresponding to a desired non-circularity of the cladding may be checked.

When the optical fiber preform is heated and melted, a degree of the non-circularity of the cladding may be adjusted by making an adiabatic material shape in the heating furnace uneven in a circumferential direction in a horizontal plane, an outer diameter of the bare optical fiber screwed by the spin may be measured, and whether or not a fluctuation range of a measured outer diameter measurement value falls in a fluctuation range corresponding to a desired non-circularity of the cladding may be checked.

When the optical fiber preform is heated and melted, a degree of the non-circularity of the cladding may be adjusted by two or more selected from misaligning a position of the optical fiber preform in a horizontal plane in the heating furnace from the center of the heating furnace, making a heater shape in the heating furnace oval in the horizontal plane, and making an adiabatic material shape in the heating furnace uneven in a circumferential direction in the horizontal plane, the outer diameter of the bare optical fiber screwed by the spin may be measured, and whether or not a fluctuation range of a measured outer diameter measurement value falls in a fluctuation range corresponding to a desired non-circularity of the cladding may be checked.

The position of the optical fiber preform may be adjusted so that a fluctuation range of the outer diameter measurement value falls in a fluctuation range corresponding to a desired non-circularity of the cladding.

In addition, in order to solve the above-described problems, according to a second aspect, there is provided a manufacturing apparatus of an optical fiber, including a heating furnace that heats and melts an optical fiber preform; a cooling device that cools a bare optical fiber drawn from a heated and melted portion of the optical fiber preform; a coating device that provides a coating layer on a surface of the cooled bare optical fiber; a curing device that cures the coating layer; a torsion application device that adds torsion to an optical fiber obtained by curing the coating layer so that spin is applied to the bare optical fiber by transmitting torsion up to the heated and melted portion from the optical fiber through the bare optical fiber; and a winding device that winds the optical fiber to which the torsion has been added, in which the heating furnace is constituted so that a non-circularity of a core in a range of 0.3% to 1% is generated in the bare optical fiber when the bare optical fiber is drawn from the optical fiber preform, the torsion application device is constituted so that the spin is applied to the bare optical fiber so that torsion in a first direction and torsion in a second direction, which is opposite to the first direction, are alternately present around a longitudinal direction of the bare optical fiber, and the torsion application device applies the spin to the bare optical fiber so that a unidirectional torsion length in the spin becomes equal to or less than a beat length converted from birefringence generated due to the non-circular core and a spin amplitude indicating a degree of unidirectional torsion in the spin reaches 30 rad or more.

According to the above-described aspects of the present invention, it becomes possible to reduce the PMD generated due to internal factors and also reduce the PMD generated due to external factors by generating a non-circular core in a bare optical fiber and generating spin in the bare optical fiber.

### BRIEF DESCRIPTION OF THE DRAWINGS

FIG. 1 is a graph showing cycle and amplitude of torsion.

FIG. 2 is a cross-sectional view of an optical fiber showing non-circularities of a core and a cladding.

FIG. 3 is a schematic view showing an example of a manufacturing apparatus of the optical fiber.

FIG. 4 is a cross-sectional view showing an example in which a center of an optical fiber preform is disarrayed from a center of a heating furnace.

FIG. 5 is a cross-sectional view showing an example of the heating furnace.

FIG. 6 is a cross-sectional view showing an example of the heating furnace in which shapes of an adiabatic material are made to be uneven.

### DETAILED DESCRIPTION OF THE INVENTION

Hereinafter, the present invention will be described on the basis of preferred embodiments with reference to the accompanying drawings.

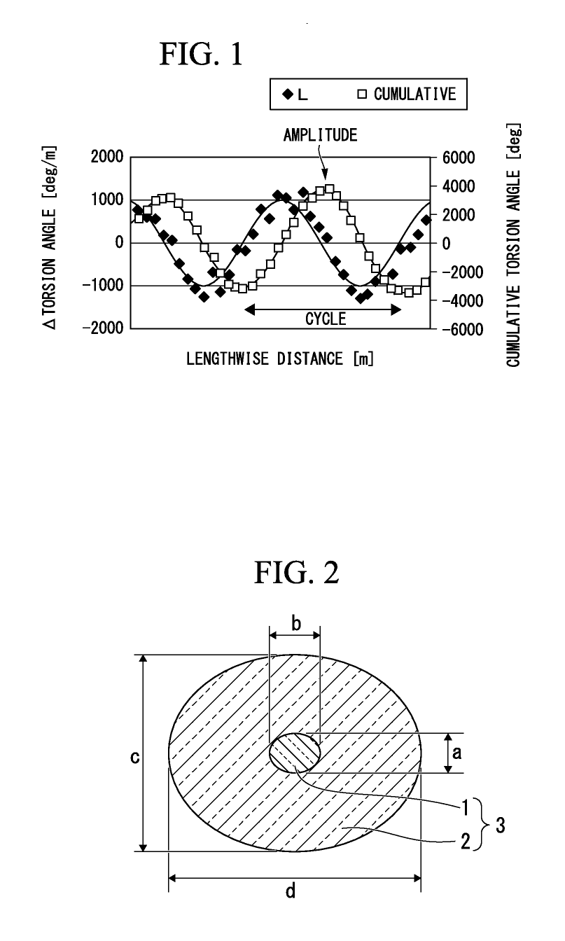

FIG. 1 is a graph showing the cycle and amplitude of torsion. The torsion of which the cycle and amplitude will be defined can be applied to both the above-described spin (permanent torsion) and the above-described twist (elastic torsion).

Regarding the positive and negative reference signs of torsion angles, any one of the two directions (clockwise direction and counterclockwise direction) around the longitudinal direction of an optical fiber is indicated using a positive reference sign and the other is indicated using a negative reference sign. The “lengthwise distance” along the horizontal axis of the graph does not indicate any specific numeric values, but is generally on the order of meters (1 m to less than 1 km). Regarding the vertical axes, the right axis line indicates the cumulative degrees of torsion angles [deg] (cumulative torsion angles) and the left axis line indicates the degrees of change per unit of length (Δ torsion angles). When the cumulative torsion angles are differentiated using the lengthwise distances, the Δ torsion angles are obtained. The line indicated using “L” indicates the lengthwise changes in the Δ torsion angle and the line indicated using “cumulative” indicates the lengthwise changes in the cumulative torsion angle. In this case, the cycle of torsion is a cycle between the lengthwise positions at which the cumulative torsion angle is minimized, but may be a cycle between the lengthwise positions at which the cumulative torsion angle is maximized. In addition, the amplitude of torsion is the maximum value (positive value) of the cumulative torsion angles, but may be the absolute value of the minimum value (negative value) of the cumulative torsion angles. In a case in which the positive reference signs of the torsion angle are determined to indicate the clockwise direction, it means that torsion changes from clockwise to counterclockwise at positions at which the cumulative torsion angle is maximized and torsion changes from counterclockwise to clockwise at positions at which the cumulative torsion angle is minimized. That is, torsion applied to an optical fiber alternately changes between clockwise and counterclockwise. As a result, positions at which the cumulative torsion angle reaches zero (0) cyclically appear in the longitudinal direction.

Clockwise torsion and counterclockwise torsion may be applied in any direction during the initial phase or in any direction during the final phase when optical fibers are manufactured. Around the longitudinal direction of a bare optical fiber, either the clockwise direction or the counterclockwise direction is considered to be a first direction and the other direction is considered to be a second direction.

In the present embodiment, in a case in which spin is applied to a bare optical fiber, the spin cycle and the spin amplitude will be respectively described using the cycle and amplitude indicated in FIG. 1. The length of a set of clockwise torsion and counterclockwise torsion is defined as the spin cycle. In addition, the degree of unidirectional torsion in the spin is defined as the spin amplitude.

The spin cycle corresponds to a length from a position at which the spin changes from the first direction to the second direction to the next position at which the spin changes from the first direction to the second direction (in the length, there is one position at which the spin changes from the second direction to the first direction).

The unidirectional torsion length in the spin is a length in which the torsion continues in either clockwise or counterclockwise and corresponds to half of the spin cycle.

Generally, an optical fiber to which spin is added is also called a spun fiber.

FIG. 2 is a cross-sectional view of an optical fiber showing a non-circularity of the core and the cladding. On a cross-section perpendicular to the longitudinal direction of an optical fiber 3, a cladding 2 is provided around a core 1.

The optical fiber 3 only including the core 1 and the cladding 2 is classified as a bare optical fiber; however, even in an optical fiber including a coating layer (not shown) around the bare optical fiber, the non-circularity of the core and non-circularity of the cladding are defined in the same manner.

In a case in which the cross-sectional shape of the core 1 is oval, the non-circularity of the core (%) is defined by the following expression using the short diameter a and long diameter b of the core 1.

non-circularity of the core (%)=(b−a)b×100

In a case in which the cross-sectional shape of the cladding 2 is oval, the non-circularity of the cladding (%) is defined by the following expression using the short diameter c and long diameter d of the cladding 2.

non-circularity of the cladding (%)=(d−c)d×100

In a case in which the cross-sectional shape is a true circle, the non-circularity (the non-circularity of the core and the non-circularity of the cladding) is 0%. In a case in which the cross-sectional shape is neither a true circle nor an oval, the non-circularity can be defined as described below through additional generalization (JIS C 6820: in the same manner as the non-circularities of the core and the cladding mentioned in the general rules of optical fibers).

Non-circularity of the core (%): When the diameter of a circle most approximate to the outer circumference of a core region is represented by the core diameter d₀ and the center of the circle is considered as the center of the core, the non-circularity of the core is the percentage value in relation to the core diameter d₀ of the difference between the diameter d₁ of a circle which has the center thereof at the center of the core and circumscribes the core region and the diameter d₂ of the largest circle which, similarly, has the center thereof at the center of the core and is included in the core region. That is, (d_{1-d}₂)/d₀×100

Non-circularity of the cladding (%): When the diameter of a circle most approximate to the surface of the cladding is represented by the cladding diameter D₀ and the center of the circle is considered as the center of the cladding, the non-circularity of the cladding is the percentage value in relation to the cladding diameter D₀ of the difference between the diameter D₁ of a circle which has the center thereof at the center of the cladding and circumscribes the surface of the cladding and the diameter D₂ of the largest circle which, similarly, has the center thereof at the center of the cladding and inscribes the surface of the cladding. That is, (D₁−D₂)/D₀×100

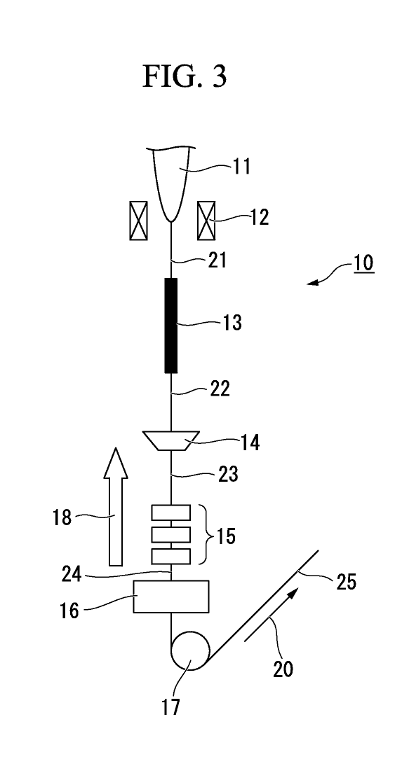

FIG. 3 schematically shows an example of a manufacturing apparatus of the optical fiber. A manufacturing apparatus of the optical fiber 10 includes a heating furnace 12, a cooling device 13, a coating device 14, curing devices 15, and a torsion application device 16. The heating furnace 12 heats and melts an optical fiber preform 11. The cooling device 13 cools a bare optical fiber 21 drawn from the optical fiber preform 11 down to a temperature at which the bare optical fiber can be coated. The coating device 14 provides a coating layer (not illustrated) to the surface of a bare optical fiber 22 that has passed through the cooling device 13. The curing devices 15 cure the coating layer on the surface of a bare optical fiber 23 that has passed through the coating device 14. The torsion application device 16 applies torsion to an optical fiber 24 that has passed through the curing devices 15.

The optical fiber preform 11 is made of silica glass and has a structure (refractive index profile) that serves as the core 1 and the cladding 2 of the optical fiber 3 (refer to FIG. 2). Examples of the silica glass include silica glass doped with a dopant such as germanium or fluorine, pure silica glass which is not doped with any dopant, and the like.

The cooling device 13 is a device that forcibly cools the bare optical fiber 21 through wind cooling or the like. There is no particular limitation regarding gas flowing in the cooling device 13 and examples thereof include air, nitrogen, argon, helium, and the like. It is also possible to naturally cool the bare optical fiber without providing the cooling device 13.

The coating layer is formed by coating the surface of the bare optical fiber 22 with a liquid-phase curable resin such as an ultraviolet-curable resin or a thermosetting resin in the coating device 14 and then curing the resin using an ultraviolet ray, heat, or the like in the curing devices 15. The curing method in the curing devices 15 is selected depending on the material of the coating layer applied by the coating device 14. The number of the coating layers provided on the surface of the bare optical fiber 22 may be two or more. In order to form two or more coating layers, the coating device 14 may be provided at two or more positions in the manufacturing apparatus of the optical fiber 10 or the coating device 14 capable of applying two or more coatings at one time may be employed. In addition, it is also possible to provide a coating device for first coating and a curing device in the front section and provide a coating device for second coating and a curing device in the rear section. In FIG. 3, the coating device 14 is provided at one position and three curing devices 15 are provided at one position behind the coating device.

The torsion application device 16 is a device that applies torsion to the optical fiber 24 that is to be wound in a winding device. From the optical fiber preform 11 through the torsion application device 16, there is no member hindering the transmission of torsion and the bare optical fiber and the optical fiber are linearly installed. Therefore, when the optical fiber is cured using the torsion application device 16, torsion is transmitted from the optical fiber 24 to the heated and melted portion of the optical fiber preform 11 through the bare optical fibers 23, 22, and 21 along a transmission direction 18 of torsion shown in FIG. 3. Therefore, torsion can be applied to the bare optical fiber 21 which is drawn from the optical fiber preform 11 and is in a melted state or a softened state. When the bare optical fiber 21 to which torsion has been applied is cooled, the torsion is permanently fixed as spin.

The torsion application device 16 applies torsion to the optical fiber 24 in a manner in which the direction of the torsion is cyclically changed so that torsion in the first direction and torsion in the second direction, which is opposite to the first direction, are alternately present as spin around the longitudinal direction of the bare optical fiber. There is no particular limitation regarding the constitution of the torsion application device 16 and it is possible to employ a well-known torsion application device in which a roller or the like is used.

A guide pulley 17 that changes the advancing direction of an optical fiber 25 that has passed through the torsion application device 16 is provided behind the heating furnace 12. On the path of the optical fiber 25 behind the guide pulley 17 in a travelling direction 20 of the optical fiber, a pulling device, a dancer pulley, the guide pulley, or the like (not shown), and, finally, the winding device (not shown) for winding the optical fiber 25 are provided.

In the present embodiment, the non-circularity of the core is generated in the bare optical fiber 21 in a drawing step in which the bare optical fiber 21 is drawn from the optical fiber preform 11. Spin is applied so that, on the basis of the beat length converted from birefringence generated due to the non-circularity of the core, the unidirectional torsion length (half of the spin cycle) reaches the beat length or less and the spin amplitude reaches 30 rad or more. Therefore, it is possible to reduce both the PMD generated due to internal factors and the PMD generated due to external factors.

In a case in which unidirectional birefringence is generated due to external factors such as pressure from a side surface or bending in the optical fiber, the PMD becomes great. Generally, when twist is applied to the optical fiber, it is possible to reduce the PMD using the rotation of a polarization plane (optical rotation) caused by elastic stress. However, in the twist, there is a disadvantage that the above-described torsion changes (returns) and thus, herein, spin is applied in place of twist.

However, the optical fiber to which spin has been applied is required to have birefringence generated due to internal factors as great as birefringence expected to be generated due to external factors during the use of the optical fiber. In order to increase the birefringence generated due to internal factors, the non-circularity of the cladding in the optical fiber is increased. When the non-circularity of the cladding in the optical fiber is increased, the non-circularity of the core also increases in the core inside the optical fiber at the same time. When spin is applied to the optical fiber in which the non-circularity of the core is generated, the birefringence axis generated due to internal factors is screwed. When the torsion caused by the spin of the birefringence axis generated due to internal factors and the unidirectional birefringence axis generated due to external factors are combined together and, consequently, birefringence is averaged in the longitudinal direction or the polarization mode coupling is increased, it is possible to maintain the PMD at a low level.

The optimal value of the degree of the non-circularity of the core in the bare optical fiber varies depending on the Young's modulus of a resin used for coating after curing or the degree of birefringence generated due to external factors that are expected, but the results of intensive studies show that, when the non-circularity of the core is set in a range of approximately 0.3% to 1%, the intensity of the non-circularity of the core becomes approximately the same as the degree of birefringence generated due to external factors that are expected during ordinary production of optical fibers in a tape (ribbon) or cable shape. In order to set the degree of the non-circularity of the core in the bare optical fiber in a range of 0.3% to 1%, the non-circularity of the cladding in the bare optical fiber is preferably set in a range of 0.3% to 1%. Generally, when birefringence by the non-circularity of the core is set on the order of 10⁻⁸, birefringence by external factors that is as great as the birefringence by the non-circularity of the core can be defined to be in a range of approximately 10⁻⁷ to 10⁻⁹. For example, the birefringence generated due to the non-circularity of the core is preferably set in a range of approximately 10⁻⁷ to 10⁻⁹. The ratio (Bᵢₙ/Bₑₓ) of the birefringence Bᵢₙ generated due to the non-circularity of the core to the birefringence Bₑₓ, by external factors is preferably in a range of approximately 10⁻² to 10⁺² and more preferably in a range of approximately 10⁻¹ to 10⁺¹.

When the birefringence by internal factors and the birefringence by external factors become substantially the same as each other as described above, the birefringence axis generated due to external factors and the birefringence axis which is generated due to internal factors and is screwed by spin are combined together. Therefore, birefringence is substantially averaged in the longitudinal direction of the optical fiber and the birefringence axis changes in the longitudinal direction and thus the polarization mode coupling is increased. Therefore, it is possible to maintain the PMD at a low level.

In a case in which the non-circularity of the core is less than 0.3%, the birefringence by internal factors becomes small. Consequently, the range of the birefringence by external factors that small birefringence by internal factors can cope with also becomes small and the PMD is increased due to the ordinary production of optical fibers in a tape or cable shape.

In a case in which the non-circularity of the core is more than 1%, the birefringence by internal factors becomes too great. Therefore, in order to obtain spin necessary to reduce the PMD generated due to internal factors, the spin profile is required to have a shorter spin cycle and a greater spin amplitude. In that case, it becomes necessary to frequently screw the optical fiber at short cycles in the manufacturing step and thus the productivity is decreased during the drawing of the optical fiber and the yield deteriorates. Therefore, the generation of an excessively great non-circularity of the core is not desirable.

When the non-circularity of the core is generated, the non-circularity of the cladding may be generated at the same time and thus both the non-circularity of the core and the non-circularity of the cladding will be collectively referred to simply as “non-circularity”. Examples of a method for controlling the non-circularity includes a method in which the non-circularity is generated in advance when an optical fiber preform is produced and a method in which an optical fiber is drawn while the non-circularity is generated. There is no particular limitation regarding the method, but the method in which the non-circularity is generated during the drawing is preferred since the non-circularity generated during the manufacturing of the optical fiber become the non-circularity in the final optical fiber and the non-circularity can be controlled during the manufacturing of the optical fiber. In addition, it is also possible to additionally generate (adjust) the non-circularity during the drawing of the optical fiber preform in which the non-circularity has been generated.

Examples of a method in which the non-circularity is generated during the manufacturing of the optical fiber preform include the following (A) to (C).

(A) In a case in which the optical fiber preform is produced using the chemical vapor deposition method, when a glass layer which serves as a part of the core and to which a dopant has been added is formed and collapsed in a silica tube having a thickness varying in the circumferential direction, the non-circularity is generated in accordance with the change in the thickness of the silica tube. In addition, since the collapsing also becomes uneven in the circumferential direction through the method for collapsing the silica tube including the glass layer formed therein, it is possible to generate the non-circularity.

(B) In a case in which the optical fiber preform is produced using the outside vapor deposition method, when a target including the non-circularity is used as the target being used in the center, glass is deposited around the target including the non-circularity, subsequently, the target is pulled off, and then the deposited tubular glass is collapsed, the non-circularity can be generated. Similar to the chemical vapor deposition method, it is also possible to generate the non-circularity by the method for collapsing the tubular glass.

(C) In the vapor-phase axial deposition method, since it is difficult to generate the non-circularity using the above-described method alone, it is possible to increase the non-circularity using a process such as elongation carried out from time to time during the manufacturing of the optical fiber preform.

The method for generating the non-circularity when the optical fiber preform is elongated is the same as the process for generating the non-circularity during drawing described below and thus will be described below in detail.

Examples of the method for generating the non-circularity during the drawing of the bare optical fiber include the following (a) to (c). It is also possible to generate the non-circularity in the bare optical fiber by jointly using two or more methods due to two or more factors.

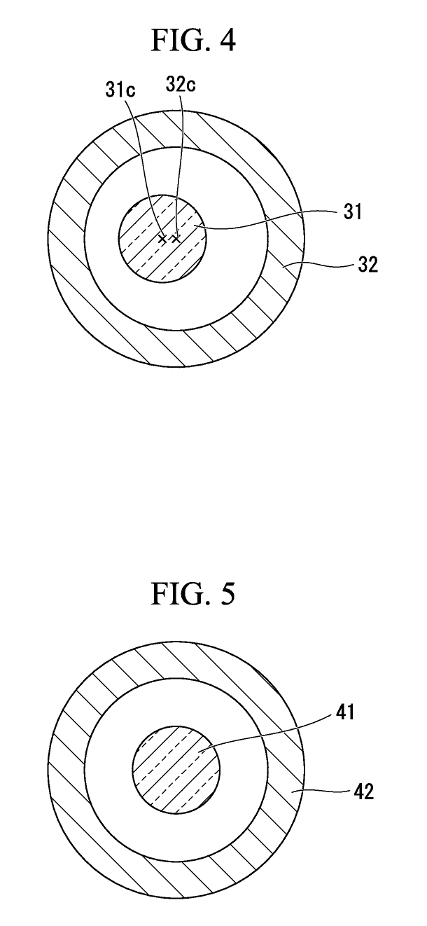

(a) When a position in the horizontal plane of an optical fiber preform 31 is moved in relation to a heating furnace 32 (is misaligned from the center 32c of the heating furnace 32) as described in FIG. 4, it is possible to bias the circumferential-direction thermal profile that is applied to the optical fiber preform 31. Therefore, it is possible to generate the non-circularity in the drawn bare optical fiber. The degree of the non-circularity can be adjusted using the degree of the misalignment of the center 31c of the optical fiber preform 31 from the center 32c of the heating furnace 32 (the misalignment degree).

(b) An optical fiber preform 41 is heated in a state in which the circumferential-direction thermal profile is biased by generating the non-circularity in the shape of a heater 42 inside the heating furnace in the horizontal plane as shown in FIG. 5. Therefore, it is possible to generate the non-circularity in a bare optical fiber drawn through the above-described process. More specifically, the cross-sectional shape of the heater 42 used for the drawing is designed to become oval.

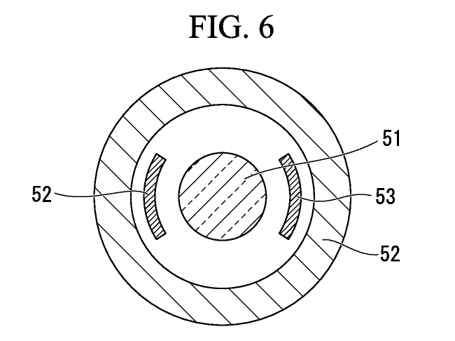

(c) An optical fiber preform 51 is heated in a state in which the circumferential-direction thermal profile is biased by making the shape of an adiabatic material 53 inside a heating furnace 52 uneven in the circumferential direction in the horizontal plane as shown in FIG. 6. Therefore, it is possible to generate the non-circularity in the drawn bare optical fiber. More specifically, the distance from the outer circumference of an optical fiber preform to the adiabatic material is adjusted or a design is made so that an adiabatic material having an adiabatic efficiency varying in the circumferential direction is used. FIG. 6 shows an example in which the adiabatic material 53 is provided at two places inside the heating furnace 52, but the provision of the adiabatic material is not limited thereto and it is possible to design the number thereof or disposition of the adiabatic material in a variety of manners.

The degree of the non-circularity in the drawn bare optical fiber can be checked during manufacturing. Particularly, the degree of the non-circularity can be checked by measuring the outer diameter of the drawn bare optical fiber being rotated and screwed in order for the application of spin using an outer diameter measurement instrument and measuring the degree of a change in the outer diameter (fluctuation range) of the bare optical fiber in the longitudinal direction. The subject of the outer diameter measurement may be the bare optical fiber before cooling or the bare optical fiber after cooling as long as it is a bare optical fiber prior to a coating layer being provided thereon. In a case in which a method for generating the non-circularity during the drawing of the bare optical fiber is employed and a case in which the degree of the non-circularity checked during manufacturing is misaligned from (or is set to be outside) the target range, the degree of the non-circularity can be adjusted by controlling the position of the optical fiber preform in the heating furnace in the horizontal plane.

In the spin profile that is applied, it is necessary to reliably reduce the PMD generated due to internal factors. Therefore, the unidirectional torsion length (half of the spin cycle) is set to be equal to or less than the beat length that is converted from birefringence generated due to the non-circular core and the spin amplitude is set to 30 rad (approximately 5 rotations) or more. When the unidirectional torsion length and the spin amplitude are set as described above, the PMD generated due to internal factors is maintained at a low level and, furthermore, birefringence generated due to internal factors and birefringence generated due to external factors are combined together in the PMD generated due to external factors. As a result, it is possible to maintain the PMD at a lower level by the averaging of birefringence and the combining of polarization modes.

The beat length converted from birefringence generated due to the non-circular core is obtained using the following expression from the birefringence of an optical fiber which includes the non-circular core but to which no spin is applied. The wavelength [m] refers to the wavelength of light used in the optical fiber in a vacuum.

Beat length [m]=wavelength [m]/birefringence

The birefringence of an optical fiber to which no spin is applied can be obtained by measuring the birefringence of an optical fiber manufactured under the same manufacturing conditions except for the fact that spin is not applied. In a case in which the relational expression between the non-circularity of the core and birefringence is obtained using a finite element method or the like, it is also possible to obtain the birefringence by measuring the non-circularity of the core of the manufactured optical fiber.

In a case in which the transmission wavelength of the optical fiber is broad, the spin cycle is desirably set so that conditions under which the unidirectional torsion length (half of the spin cycle) becomes equal to or less than the beat length are satisfied at all wavelengths.

Thus far, the present invention has been described on the basis of a preferred embodiment, but the present invention is not limited to the above-described embodiment and a variety of modifications are allowed within the scope of the gist of the present invention.

The transmission wavelength of the optical fiber is not particularly limited and examples thereof include wavelength bands such as an O band (1260 nm to 1360 nm), an E band (1360 nm to 1460 nm), a C band (1530 nm to 1565 nm), and an L band (1565 nm to 1625 nm).

### EXAMPLES

Hereinafter, the present invention will be specifically described using examples.

A manufacturing method of an optical fiber common in Examples 1 to 3 and Comparative Examples 1 and 2 is as described below.

The optical fiber preform 11 for a single mode optical fiber was heated and melted in the heating furnace 12 using the manufacturing apparatus of the optical fiber 10 shown in FIG. 3 so as to draw a bare optical fiber 21 having φ125 μm and the outer diameter of the optical fiber was measured using an outer diameter measurement instrument (not shown). Next, the bare optical fiber was cooled down to a temperature appropriate for coating in the cooling device 13, then, the bare optical fiber was coated with an ultraviolet-curable resin using the coating device 14, and a coating layer was cured in the curing device 15 including an UV irradiation device. Next, a torsion torque was added to the optical fiber 24 using the torsion application device 16 and then the optical fiber was pulled and was wound using a winding device (not shown).

The torsion torque added to the optical fiber 24 using the torsion application device 16 is transmitted toward the optical fiber preform 11 (generally, toward the front section of the manufacturing apparatus of the optical fiber 10), the heated and melted portion of the optical fiber preform 11 was screwed in the heating furnace 12, and spin was applied to the bare optical fiber 21.

The stationary drawing conditions are a drawing velocity of 2500 m/min and a drawing tension of 3 N. When no spin was applied, the fluctuation range of the outer diameter of the optical fiber was approximately φ125 μm±0.1 μm.

Here, the “outer diameter of the optical fiber” in Examples 1 to 3 and Comparative Examples 1 and 2 refers to the outer diameter of the bare optical fiber 21 that has been drawn but has yet to pass through the cooling device 13.

The relational expression between the non-circularity of the core and birefringence analyzed using a finite element method and the conversion expression from birefringence to the beat length are as described below. As the coefficient included in the relational expression between the non-circularity of the core and birefringence, in a case in which the manufacturing conditions such as those for the manufacturing apparatus are common, the same value can be used; however, otherwise, the coefficient needs to be separately obtained. The wavelength was set to 1.55×10⁻⁶ [m].

Birefringence=7.369×10⁻⁸×non-circularity of the core [%]

Beat length [m]=wavelength [m]/birefringence

### Example 1

### Manufacturing of Optical Fiber Expected to be Used in Loose Tube Cable

In Example 1, the fluctuation range of the outer diameter of a bare optical fiber during the application of spin was adjusted so as to reach approximately φ125 μm±0.2 μm by adjusting the position of an optical fiber preform in relation to the heating furnace. At this time, the positional misalignment between the center of the optical fiber preform and the center of the heating furnace was approximately 10 mm. The non-circularity of the cladding (≈the non-circularity of the core) obtained from the fluctuation range of the outer diameter of the optical fiber corresponds to approximately 0.3%. When the non-circularity is roughly computed using the fluctuation range of the outer diameter of the optical fiber/the outer diameter of the optical fiber, 0.4 μm/125 μm=0.32%. When the relational expression analyzed using the finite element method and the conversion expression from birefringence to the beat length are used, the beat length of 0.3% of the non-circularity of the core can be assumed to be approximately 70 m. Therefore, the spin conditions were set to a spin cycle of 30 m and a spin amplitude of 30 rad (that is, 1 rotation per approximately 3 m). In this case, the unidirectional torsion length (half of the spin cycle) is equal to or less than the beat length. In addition, birefringence generated due to the non-circularity of the core can be assumed to be approximately 2.2×10⁻⁸.

As a result of measuring the non-circularity of the cladding and the non-circularity of the core in the manufactured optical fiber, both of the non-circularities of the core and cladding were 0.3%. A prototype of a loose tube cable was produced using the optical fiber, and the PMD was measured and was 0.04 ps/√km, which was sufficiently small.

### Example 2

### Manufacturing of Optical Fiber Expected to be Used in Tape Slot Cable

In Example 2, the heater shape was adjusted so that the fluctuation range of the outer diameter of a bare optical fiber during the application of spin reached approximately φ125 μm±0.6 μm by adjusting the heater shape used in the heating furnace to be an oval shape. As a result, the oblateness of the oval shape of the heater, that is, (the long radius-the short radius)/the long radius was 5%. The non-circularity of the cladding (≈the non-circularity of the core) obtained from the fluctuation range of the outer diameter of the optical fiber corresponds to approximately 1%. When the non-circularity is roughly computed using the fluctuation range of the outer diameter of the optical fiber/the outer diameter of the optical fiber, 1.2 μm/125 μm=0.96%. When the relational expression analyzed using the finite element method and the conversion expression from birefringence to the beat length are used, the beat length of 1% of the non-circularity of the core can be assumed to be approximately 21 m. Therefore, the spin conditions were set to a spin cycle of 40 m and a spin amplitude of 60 rad (that is, 1 rotation every approximately 2 m). In this case, the unidirectional torsion length (half of the spin cycle) is equal to or less than the beat length. In addition, birefringence generated due to the non-circular core can be assumed to be approximately 7.4×10⁻⁸.

As a result of measuring the non-circularity of the cladding and the non-circularity of the core in the manufactured optical fiber, both of the non-circularities of the core and cladding were 1%. A prototype of a tape slot cable was produced using the optical fiber, and the PMD was measured and was 0.05 ps/√km, which was sufficiently small.

### Example 3

### No External Factors: Optical Fiber Single Body

In Example 3, the shape of an adiabatic material was adjusted so that the fluctuation range of the outer diameter of a bare optical fiber during the application of spin reached approximately φ125 μm±0.3 μm by making the shape of the adiabatic material used in the heating furnace uneven in the circumferential direction. The non-circularity of the cladding (≈the non-circularity of the core) obtained from the fluctuation range of the outer diameter of the optical fiber corresponds to approximately 0.5%. When the non-circularity is roughly computed using the fluctuation range of the outer diameter of the optical fiber/the outer diameter of the optical fiber, 0.6 μm/125 μm=0.48%. When the relational expression analyzed using the finite element method and the conversion expression from birefringence to the beat length are used, the beat length of 0.5% of the non-circularity of the core can be assumed to be approximately 42 m. Therefore, the spin conditions were set to a spin cycle of 20 m and a spin amplitude of 30 rad (that is, 1 rotation approximately every 2 m). In this case, the unidirectional torsion length (half of the spin cycle) is equal to or less than the beat length. In addition, birefringence generated due to the non-circularity of the core can be assumed to be approximately 3.7×10⁻⁸.

As a result of measuring the non-circularities of the core and cladding in the manufactured optical fiber, both of the non-circularities of the core and cladding were found to be 0.5%. As a result of measuring the PMD of the optical fiber in a wound state like a reel, the PMD was found to be 0.03 ps/√km, which was sufficiently small.

### Comparative Example 1

### Comparative Example in Relation to Example 1

In Comparative Example 1, the fluctuation range of the outer diameter of a bare optical fiber during the application of spin was adjusted so as to reach approximately φ125 μm±0.1 μm by adjusting the position of an optical fiber preform in relation to the heating furnace. At this time, there was almost no positional misalignment between the center of the optical fiber preform and the center of the heating furnace.

The non-circularity of the cladding (the non-circularity of the core) obtained from the fluctuation range of the outer diameter of the optical fiber corresponds to approximately 0.15%. When the non-circularity is roughly computed using the fluctuation range of the outer diameter of the optical fiber/the outer diameter of the optical fiber, 0.2 μm/125 μm=0.16%. When the relational expression analyzed using the finite element method and the conversion expression from birefringence to the beat length are used, the beat length of 0.15% of the non-circularity of the core can be assumed to be approximately 140 m. Therefore, the spin conditions were set to a spin cycle of 30 m and a spin amplitude of 30 rad (that is, 1 rotation approximately every 3 m). In this case, the unidirectional torsion length (half of the spin cycle) is equal to or less than the beat length. In addition, birefringence generated due to the non-circularity of the core can be assumed to be approximately 1.1×10⁻⁸.

As a result of measuring the non-circularities of the core and cladding in the manufactured optical fiber, both of the non-circularities of the core and cladding were found to be 0.15%. A prototype of a loose tube cable was produced using the optical fiber, and the PMD was measured and was 0.10 ps/√km, which was greater than in Example 1.

This is considered to be because the birefringence by external factors caused by the loose tube was more than 10 times greater than the birefringence by internal factors, thus, the influence of the birefringence by external factors was great, the influence of torsion of the birefringence axis caused by internal factors was not generated, and thus the PMD-reducing effect was small.

### Comparative Example 2

### Comparative Example in Relation to Example 2

In Comparative Example 2, the heater shape was adjusted so that the fluctuation range of the outer diameter of a bare optical fiber during the application of spin reached approximately φ125 μm±1 μm by adjusting the heater shape used in the heating furnace to be an oval shape. As a result, the oblateness of the oval shape of the heater, that is, (the long radius-the short radius)/the long radius was 10%. The non-circularity of the cladding (≈the non-circularity of the core) obtained from the fluctuation range of the outer diameter of the optical fiber corresponds to approximately 1.6%. When the non-circularity is roughly computed using the fluctuation range of the outer diameter of the optical fiber/the outer diameter of the optical fiber, 2 μm/125 μm=1.6%. When the relational expression analyzed using the finite element method and the conversion expression from birefringence to the beat length are used, the beat length of 1.6% of the non-circularity of the core can be assumed to be approximately 13 m. Therefore, the spin conditions were set to a spin cycle of 40 m and a spin amplitude of 60 rad (that is, 1 rotation approximately every 2 m). In this case, the unidirectional torsion length (half of the spin cycle) is greater than the beat length. In addition, birefringence generated due to the non-circularity of the core can be assumed to be approximately 1.2×10⁻⁷.

As a result of measuring the non-circularities of the core and the cladding in the manufactured optical fiber, both of the non-circularities of the core and the cladding were found to be 1.6%. A prototype of a tape slot cable was produced using the optical fiber, and the PMD was measured and was 0.15 ps/√km, which was greater than in Example 2.

This is considered to be because the birefringence by external factors caused by the tape slot cable was less than 10 times the birefringence by internal factors, the influence of the birefringence by internal factors was great, furthermore, the spin cycle was long, and thus the PMD-reducing effect was small.

While preferred embodiments of the invention have been described and shown above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A manufacturing method of an optical fiber, comprising:
heating and melting an optical fiber preform;
drawing a bare optical fiber from a heated and melted portion of the optical fiber preform;
cooling the bare optical fiber drawn from the optical fiber preform;
forming a coating layer on a surface of the cooled bare optical fiber;
obtaining an optical fiber by curing the coating layer;
adding torsion to the optical fiber by transmitting the torsion up to the heated and melted portion through the bare optical fiber from the optical fiber so that spin is applied to the bare optical fiber; and
winding the optical fiber, wherein
when the bare optical fiber is drawn from the heated and melted portion, generating a non-circularity of a core in a range of 0.3% to 1% in the bare optical fiber is performed,
when the torsion is added to the optical fiber, applying the spin to the bare optical fiber is performed so that torsion in a first direction and torsion in a second direction, which is opposite to the first direction, are alternately present around a longitudinal direction of the bare optical fiber, and
when the torsion is added to the optical fiber, applying the spin to the bare optical fiber is performed so that a unidirectional torsion length in the spin becomes equal to or less than a beat length converted from birefringence generated due to a non-circular core and an amplitude of the spin indicating a degree of unidirectional torsion in the spin reaches 30 rad or more.

2. The manufacturing method of an optical fiber according to claim 1, further comprising:
when the bare optical fiber is drawn from the heated and melted portion, generating the non-circularity of the core so that birefringence generated due to the non-circular core falls in a range of 10⁻⁷ to 10⁻⁹.

3. The manufacturing method of an optical fiber according to claim 1, further comprising:
when the bare optical fiber is drawn from the heated and melted portion, generating the non-circularity of the core so that a value of a ratio between birefringence generated due to the non-circularity of the core and birefringence by external factors expected to be applied in applications of the optical fiber falls in a range of 10⁻² to 10⁺².

4. The manufacturing method of an optical fiber according to claim 1, further comprising:
when the bare optical fiber is drawn from the heated and melted portion, generating a non-circularity of a cladding in a range of 0.3% to 1% in the bare optical fiber.

5. The manufacturing method of an optical fiber according to claim 4, further comprising:
when the optical fiber preform is heated and melted, adjusting a degree of the non-circularity of the cladding by misaligning a position of the optical fiber preform in a horizontal plane in the heating furnace from a center of the heating furnace; and
measuring an outer diameter of the bare optical fiber screwed by the spin, and checking whether or not a fluctuation range of a measured outer diameter measurement value falls in a fluctuation range corresponding to a desired non-circularity of the cladding.

6. The manufacturing method of an optical fiber according to claim 4, further comprising:
when the optical fiber preform is heated and melted, adjusting a degree of the non-circularity of the cladding by making a heater shape in the heating furnace oval in a horizontal plane; and
measuring an outer diameter of the bare optical fiber screwed by the spin, and checking whether or not a fluctuation range of a measured outer diameter measurement value falls in a fluctuation range corresponding to a desired non-circularity of the cladding.

7. The manufacturing method of an optical fiber according to claim 4, further comprising:
when the optical fiber preform is heated and melted, adjusting a degree of the non-circularity of the cladding by making an adiabatic material shape in the heating furnace uneven in a circumferential direction in a horizontal plane; and
measuring an outer diameter of the bare optical fiber screwed by the spin, and checking whether or not a fluctuation range of a measured outer diameter measurement value falls in a fluctuation range corresponding to a desired non-circularity of the cladding.

8. The manufacturing method of an optical fiber according to claim 4, further comprising:
when the optical fiber preform is heated and melted, adjusting a degree of the non-circularity of the cladding by two or more selected from misaligning a position of the optical fiber preform in a horizontal plane in the heating furnace from a center of the heating furnace, making a heater shape in the heating furnace oval in the horizontal plane, and making an adiabatic material shape in the heating furnace uneven in a circumferential direction in the horizontal plane; and
measuring an outer diameter of the bare optical fiber screwed by the spin, and checking whether or not a fluctuation range of a measured outer diameter measurement value falls in a fluctuation range corresponding to a desired non-circularity of the cladding.

9. The manufacturing method of an optical fiber according to claim 5, further comprising:
adjusting the position of the optical fiber preform so that a fluctuation range of the outer diameter measurement value falls in a fluctuation range corresponding to a desired non-circularity of the cladding.

10. The manufacturing method of an optical fiber according to claim 6, further comprising:
adjusting the position of the optical fiber preform so that a fluctuation range of the outer diameter measurement value falls in a fluctuation range corresponding to a desired non-circularity of the cladding.

11. The manufacturing method of an optical fiber according to claim 7, further comprising:
adjusting the position of the optical fiber preform so that a fluctuation range of the outer diameter measurement value falls in a fluctuation range corresponding to a desired non-circularity of the cladding.

12. The manufacturing method of an optical fiber according to claim 8, further comprising:
adjusting the position of the optical fiber preform so that a fluctuation range of the outer diameter measurement value falls in a fluctuation range corresponding to a desired non-circularity of the cladding.

13. A manufacturing apparatus of an optical fiber, comprising:
a heating furnace that heats and melts an optical fiber preform;
a cooling device that cools a bare optical fiber drawn from a heated and melted portion of the optical fiber preform;
a coating device that provides a coating layer to a surface of the cooled bare optical fiber;
a curing device that cures the coating layer;
a torsion application device that adds torsion to an optical fiber obtained by curing the coating layer so that spin is applied to the bare optical fiber by transmitting torsion up to the heated and melted portion from the optical fiber through the bare optical fiber; and
a winding device that winds the optical fiber to which the torsion has been added, wherein
the heating furnace is constituted so that a non-circularity of a core in a range of 0.3% to 1% is generated in the bare optical fiber when the bare optical fiber is drawn from the optical fiber preform,
the torsion application device is constituted so that the spin is applied to the bare optical fiber so that torsion in a first direction and torsion in a second direction, which is opposite to the first direction, are alternately present around a longitudinal direction of the bare optical fiber, and
the torsion application device applies the spin to the bare optical fiber so that a unidirectional torsion length in the spin becomes equal to or less than a beat length converted from birefringence generated due to the non-circular core and a spin amplitude indicating a degree of unidirectional torsion in the spin reaches 30 rad or more.
